(19) United States
(12) Patent Application Publication
(10) Pub. No.: US 2013/0138808 A1
(43) Pub. Date: May 30, 2013

(54) MONITORING AND MANAGING DATA STORAGE DEVICES

(71) Applicant: KOBY BILLER, REHOVOT (IL)

(72) Inventor: KOBY BILLER, REHOVOT (IL)

(21) Appl. No.: 13/688,232

(22) Filed: Nov. 29, 2012

Related U.S. Application Data
(60) Provisional application No. 61/564,349, filed on Nov. 29, 2011.

(51) Int. Cl. G06F 11/30

(52) U.S. Cl. CPC G06F 11/3006
USPC 709/224

(57) ABSTRACT

Monitoring and managing multiple data storage devices in association with multiple computers by obtaining at a data storage device manager a value for an attribute associated with at least one data storage device that is accessible to a first computer, obtaining at the data storage device manager a value for an attribute associated with at least one data storage device that is accessible to a second computer that is separate from the first computer, determining at the data storage device manager whether any of the attribute values meets a predefined condition that is associated with the attribute, and if any of the attribute values meets the predefined condition, causing any of the computers from which the attribute value was received to perform a maintenance operation in association with the data storage device that is associated with the attribute value.

### CROSS-REFERENCE TO RELATED APPLICATIONS

This application claims the benefit of priority of U.S. Provisional Patent Application No. 61/564,349, filed on Nov. 29, 2011, which is incorporated herein by reference in its entirety.

### FIELD OF THE INVENTION

The invention relates to storage devices in general, and more particularly to the management and monitoring of data storage devices.

### BACKGROUND OF THE INVENTION

Managing an organization's numerous and diverse data storage devices, such as magnetic storage devices, optical storage devices, and flash storage devices, poses challenges since organizations typically rely on end users to both be aware of their storage device metrics, such as fragmentation and utilization levels, as well as to perform periodic maintenance operations to address those metrics, such as by performing defragmentation of the storage device and erasing files that are no longer needed. As an organization may have many such data storage devices, indifference or neglect by end users to manage their data storage devices results in inefficiencies at the organizational level.

### SUMMARY OF THE INVENTION

In one aspect of the invention a method is provided for monitoring and managing multiple data storage devices in association with multiple computers, the method including obtaining at a data storage device manager a value for an attribute associated with at least one data storage device that is accessible to a first computer, obtaining at the data storage device manager a value for an attribute associated with at least one data storage device that is accessible to a second computer that is separate from the first computer, determining at the data storage device manager whether any of the attribute values meets a predefined condition that is associated with the attribute, and if any of the attribute values meets the predefined condition, causing any of the computers from which the attribute value was received to perform a maintenance operation in association with the data storage device that is associated with the attribute value.

In another aspect of the invention the obtaining steps are performed with respect to different data storage devices.

In another aspect of the invention the obtaining steps are performed where the attribute associated with the attribute value of the first obtaining step is the same as the attribute associated with the attribute value of the second obtaining step.

In another aspect of the invention the obtaining steps are performed where the attribute associated with the attribute value of the first obtaining step is different from the attribute associated with the attribute value of the second obtaining step.

In another aspect of the invention any of the obtaining steps includes obtaining where the attribute is a fragmentation level.

In another aspect of the invention the determining step is performed at a third computer that is separate from the first computer and the second computer.

In another aspect of the invention the causing step includes performing the maintenance operation on the data storage device via the computer to which the data storage device is accessible.

In another aspect of the invention the causing step includes causing where the maintenance operation modifies the attribute value of the data storage device.

In another aspect of the invention the causing step includes causing where the maintenance operation includes performing a defragmentation operation.

In another aspect of the invention further includes generating a report based on the attribute values for each of the data storage devices.

In another aspect of the invention a system is provided for monitoring and managing multiple data storage devices in association with multiple computers, the system including a DSD attribute collector configured to obtain a value for an attribute associated with at least one data storage device that is accessible to a first computer, and obtain a value for an attribute associated with at least one data storage device that is accessible to a second computer that is separate from the first computer, an attribute analyzer configured to determine whether any of the attribute values meets a predefined condition that is associated with the attribute, and a DSD agent configured to cause a maintenance operation to be performed in association with any of the data storage devices associated with any of the attribute values that meets the predefined condition. In another aspect of the invention the DSD agent is configured to provide the attribute values to the DSD attribute collector.

In another aspect of the invention the DSD agent is configured with the first computer and a second DSD agent is configured with the second computer.

In another aspect of the invention the attribute values are for the same attribute.

In another aspect of the invention the attribute values are for different attributes.

In another aspect of the invention the DSD attribute collector and the attribute analyzer are implemented by a third computer.

In another aspect of the invention the attribute is a fragmentation level.

In another aspect of the invention the DSD agent is further configured to perform the maintenance operation on any of the data storage devices associated with any of the attribute values that meets the predefined condition.

In another aspect of the invention the maintenance operation modifies the attribute value of the data storage device regarding which the maintenance operation is performed.

In another aspect of the invention the maintenance operation is a defragmentation operation.

In another aspect of the invention further includes a mapper that is configured to generate a report based on the attribute values for each of the data storage devices.

In another aspect of the invention the DSD attribute collector, attribute analyzer, and DSD agent are embodied in any of a) computer hardware, and b) computer software embodied in a non-transitory, computer-readable medium.

In another aspect of the invention a computer program product is provided for monitoring and managing multiple data storage devices in association with multiple computers, the computer program product including a computer-readable storage medium and computer-readable program code embodied in the computer-readable storage medium, where the computer-readable program code is configured to obtain at a data storage device manager a value for an attribute associated with at least one data storage device that is accessible to a first computer, obtain at the data storage device manager a value for an attribute associated with at least one data storage device that is accessible to a second computer that is separate from the first computer, determine at the data storage device manager whether any of the attribute values meets a predefined condition that is associated with the attribute, and if any of the attribute values meets the predefined condition, cause any of the computers from which the attribute value was received to perform a maintenance operation in association with the data storage device that is associated with the attribute value.

### BRIEF DESCRIPTION OF THE DRAWINGS

The invention will be understood and appreciated more fully from the following detailed description taken in conjunction with the appended drawings in which:

FIG. 1 is a simplified conceptual illustration of a system for monitoring and managing multiple data storage devices associated with multiple computers, constructed and operative in accordance with an embodiment of the invention;

FIGS. 2A and 2B are sample reports that may be produced in accordance with the invention;

FIG. 3 is a simplified flowchart illustration of an exemplary method of operation of the system of FIG. 1, operative in accordance with an embodiment of the invention; and

FIG. 4 is a simplified block diagram illustration of an exemplary hardware implementation of a computing system, constructed and operative in accordance with an embodiment of the invention.

### DETAILED DESCRIPTION OF THE INVENTION

The invention is now described within the context of one or more embodiments, although the description is intended to be illustrative of the invention as a whole, and is not to be construed as limiting the invention to the embodiments shown. It is appreciated that various modifications may occur to those skilled in the art that, while not specifically shown herein, are nevertheless within the true spirit and scope of the invention.

As will be appreciated by one skilled in the art, aspects of the present invention may be embodied as a system, method or computer program product. Accordingly, aspects of the present invention may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, aspects of the present invention may take the form of a computer program product embodied in one or more computer readable medium(s) having computer readable program code embodied thereon.

Any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical data storage device, a magnetic data storage device, or any suitable combination of the foregoing. In the context of this document, a computer readable storage medium may be any tangible medium that can contain, or store a program for use by or in connection with an instruction execution system, apparatus, or device.

A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device.

Program code embodied on a computer readable medium may be transmitted using any appropriate medium, including but not limited to wireless, wireline, optical fiber cable, RF, etc., or any suitable combination of the foregoing.

Computer program code for carrying out operations for aspects of the present invention may be written in any combination of one or more programming languages, including an object oriented programming language such as Java, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Aspects of the present invention are described below with reference to flowchart illustrations and/or block diagrams of methods, apparatus (systems) and computer program products according to embodiments of the invention. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer readable medium that can direct a computer, other programmable data processing apparatus, or other devices to function in a particular manner, such that the instructions stored in the computer readable medium produce an article of manufacture including instructions which implement the function/act specified in the flowchart and/or block diagram block or blocks.

The computer program instructions may also be loaded onto a computer, other programmable data processing apparatus, or other devices to cause a series of operational steps to be performed on the computer, other programmable apparatus or other devices to produce a computer implemented process such that the instructions which execute on the computer or other programmable apparatus provide processes for implementing the functions/acts specified in the flowchart and/or block diagram block or blocks.

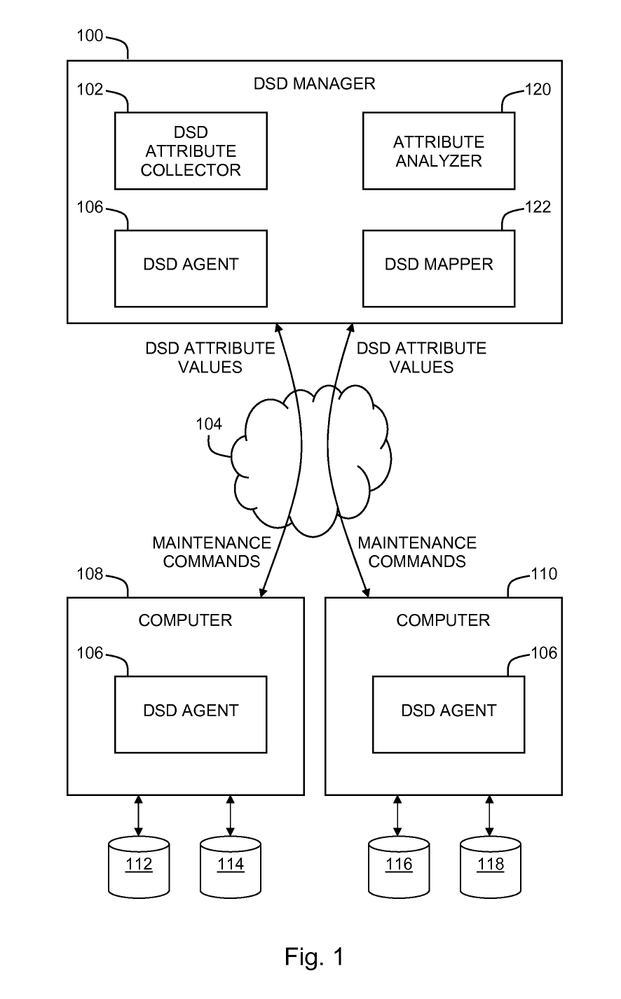

Reference is now made to FIG. 1, which is a simplified conceptual illustration of a system for monitoring and managing multiple data storage devices in association with multiple computers, constructed and operative in accordance with an embodiment of the invention. In the system of FIG. 1, a data storage device (DSD) manager 100, which may be implemented by and/or embodied in a computer (not shown), preferably includes a DSD attribute collector 102 for obtaining, such as via a computer network 104, one or more DSD attribute values from DSD agents 106 at one or more computers, such as computers 108 and 110. Data storage device agents 106 are preferably configured to determine values of one or more attributes associated with one or more DSDs that are accessible to computers 108 and 110, such as DSDs 112, 114, 116, and 118, which may include any type of data storage media, such as, for example, magnetic storage devices, optical storage devices, and flash storage devices. Such attributes may include any type of information that is associated with DSDs, such as, for example, manufacturer information, storage capacity, data file fragmentation level, utilization level, and temperature. In one embodiment computers 108 and 110 are preconfigured with DSD agents 106. In another embodiment storage device manager 100, in accordance with conventional techniques, is configured to provide copies of DSD agent 106 to computers 108 and 110 and cause computers 108 and 110 to execute their copies of storage device agent 106.

DSD manager 100 is preferably configured to maintain DSD attribute values at an attribute store 112, where each DSD attribute value is preferably maintained in association with the computer from which the attribute value was received, the DSD associated with the attribute value, and the date and time when the attribute value was obtained. Data storage device manager 100 preferably includes an attribute analyzer 120 configured to analyze the DSD attribute values and determine if any of the attribute values meets a predefined condition that is associated with the attribute, such as if an attribute value falls outside the boundary of a predefined threshold. If an attribute value is determined to meet the predefined condition, such as exceeding a maximum fragmentation level, DSD manager 100 preferably causes DSD agent 106 at the computer from which the attribute value was received to perform a maintenance operation with respect to the DSD that is associated with the attribute value, such as by performing a defragmentation operation on the DSD to modify its fragmentation level.

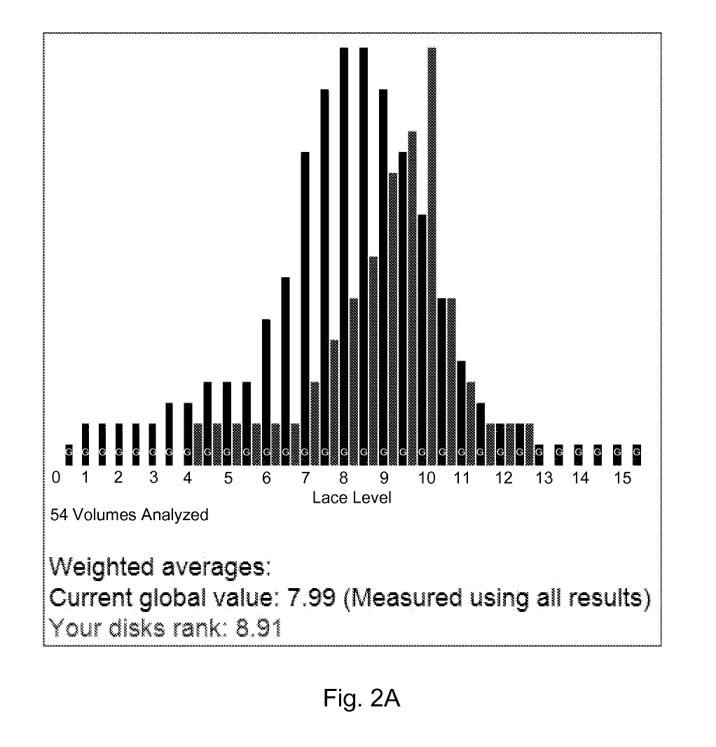

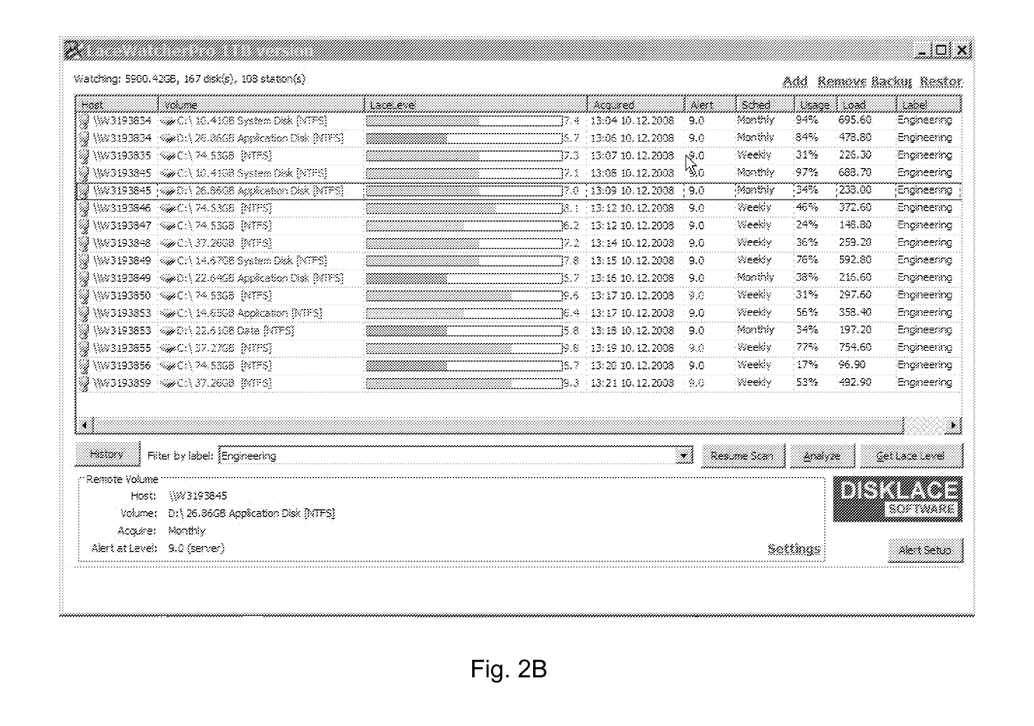

Data storage device manager 100 also preferably includes a DSD mapper 122 configured to generate a report from any of the information maintained in attribute store 112. For example, FIG. 2A shows one type of report in which a graph is shown, where the bars labeled with a “G” represent Lace Levels of data storage devices across multiple organizations, while the remaining bars represent the comparative Lace Levels of data storage devices at a single organization or department. The term “Lace Level” as used herein represents a statistical scalar factor that can be calculated for any storage device with respect to historical measurements taken of data storage devices of different types and sizes. A method for calculating the Lace Level for any data storage device is described in “A New Approach to Storage Management Restrictions Using the ‘Data Quality’ Concept” by Koby Biller, which is available at “http://www.disklace.com/Approach Storage Manag CET ABK0KA.pdf”, the use of which is also described in U.S. Pat. No. 8,051,115 B2, the disclosures of which are incorporated herein by reference in their entirety. In addition, the weighted average for each distribution is calculated and enables a significant single number comparison of the checked disks of a specific customer to the global distribution.

FIG. 2B shows another type of report in which various attribute values are shown for different data storage devices associated with different computers, where each row of the report relates to a different data storage device. Thus, the row beginning with the label “\\W3193834” includes the following attributes and their values:
Host, which includes an identifier of the computer that is associated with the data storage device
Volume, which indicates a volume name associated with the data storage device, the capacity of the data storage device, and the storage format (e.g., NTFS)
The lace level of the data storage device
Acquired, which indicates when the attribute values were last acquired
Alert, which is set by the system administrator and indicates the value beyond which an automatic action is required
Sched, is set by the system administrator according to the activity on the specific device and indicates the time that has elapsed between two consecutive scans of the device
Usage, which indicates the capacity utilization of the device
Load, which is the capacity of the device multiplied by the Lace Level of the device, and provides a quick reference to storage devices having potential disorder problems
Label, which is set by the system administrator and indicates an organic group of devices having similar usage patterns that can be viewed at a glance.

The reports may be used by a system administrator to:
Identify particular storage units that require maintenance, which may be performed automatically as described hereinabove, or which may be manually initiated by the system administrator
Obtain storage utilization and maintenance status information for an entire organization or any subset thereof, such as at the department or user levels
Receive a single measurement describing a weighted service level of the disorder of data on the measured storage devices.

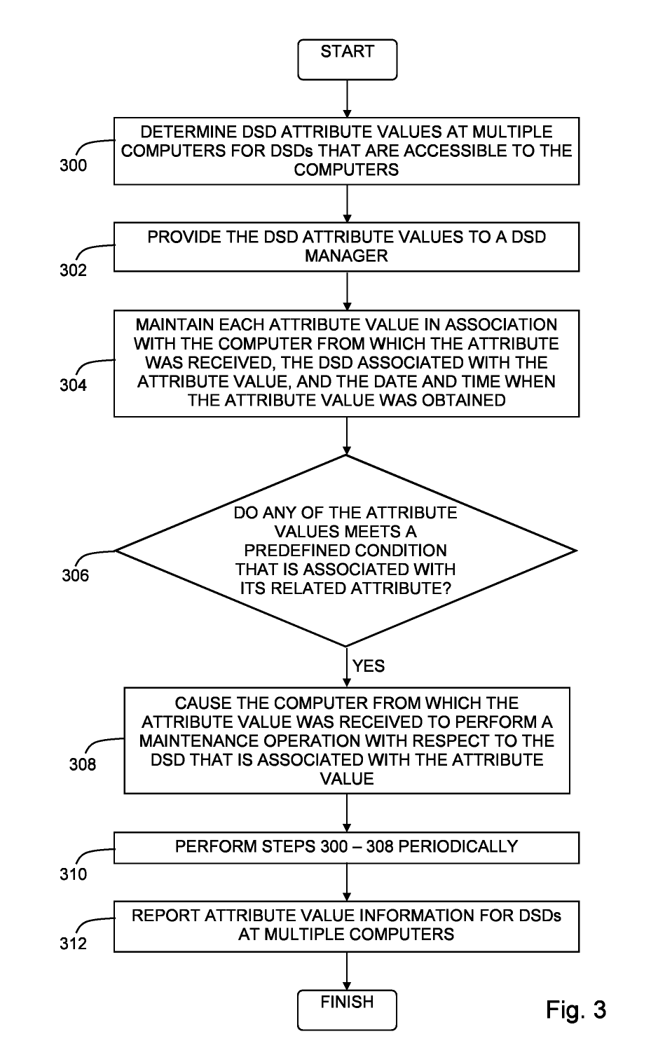

Reference is now made to FIG. 3, which is a simplified flowchart illustration of an exemplary method of operation of the system of FIG. 1, operative in accordance with an embodiment of the invention. In the method of FIG. 3, DSD attribute values are determined at multiple computers for DSDs that are accessible to the computers (step 300). The DSD attribute values are provided to a DSD manager (step 302) and maintained in association with the computer from which the attribute was received, the DSD associated with the attribute value, and the date and time when the attribute value was obtained (step 304). The attribute values are analyzed by the DSD manager to determine if any of the attribute values meets a predefined condition that is associated with the attribute (step 306). If an attribute value meets such a condition, the DSD manager causes the computer from which the attribute value was received to perform a maintenance operation with respect to the DSD that is associated with the attribute value (step 308). Steps 300-308 are preferably performed periodically, such as at predefined times or time intervals (step 310), and reports are preferably generated from the attribute value information described above, preferably providing a consolidated report for DSDs at multiple computers, such as for use by system administrators (step 312).

It will be appreciated that the system of FIG. 1 and method of FIG. 2 may be employed in a manner that is complementary to existing computer maintenance approaches, as the invention provides system administrators with a consolidated, organization-wide view of the organization's data storage devices and data storage health, as well as a way of centrally monitoring and managing the organization's data storage devices as a consolidated, organization-level resource, in contrast to conventional approaches that view data storage as a computer-level resource that is to be monitored and managed on a per-computer basis.

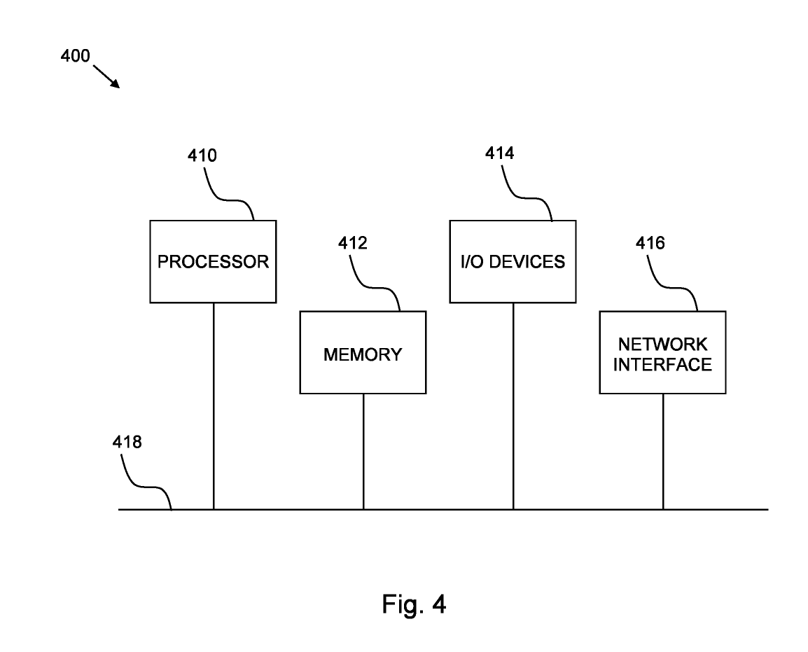

Referring now to FIG. 4, block diagram 400 illustrates an exemplary hardware implementation of a computing system in accordance with which one or more components/methodologies of the invention (e.g., components/methodologies described in the context of FIGS. 1-2) may be implemented, according to an embodiment of the invention.

As shown, the techniques for controlling access to at least one resource may be implemented in accordance with a processor 410, a memory 412, I/O devices 414, and a network interface 416, coupled via a computer bus 418 or alternate connection arrangement.

It is to be appreciated that the term “processor” as used herein is intended to include any processing device, such as, for example, one that includes a CPU (central processing unit) and/or other processing circuitry. It is also to be understood that the term “processor” may refer to more than one processing device and that various elements associated with a processing device may be shared by other processing devices.

The term “memory” as used herein is intended to include memory associated with a processor or CPU, such as, for example, RAM, ROM, a fixed memory device (e.g., hard drive), a removable memory device (e.g., diskette), flash memory, etc. Such memory may be considered a computer readable storage medium.

In addition, the phrase “input/output devices” or “I/O devices” as used herein is intended to include, for example, one or more input devices (e.g., keyboard, mouse, scanner, etc.) for entering data to the processing unit, and/or one or more output devices (e.g., speaker, display, printer, etc.) for presenting results associated with the processing unit.

The flowchart and block diagrams in the Figures illustrate the architecture, functionality, and operation of possible implementations of systems, methods and computer program products according to various embodiments of the invention. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

It will be appreciated that any of the elements described hereinabove may be implemented as a computer program product embodied in a computer-readable medium, such as in the form of computer program instructions stored on magnetic or optical storage media or embedded within computer hardware, and may be executed by or otherwise accessible to a computer.

While the methods and apparatus herein may or may not have been described with reference to specific computer hardware or software, it is appreciated that the methods and apparatus described herein may be readily implemented in computer hardware or software using conventional techniques.

While the invention has been described with reference to one or more specific embodiments, the description is intended to be illustrative of the invention as a whole and is not to be construed as limiting the invention to the embodiments shown. It is appreciated that various modifications may occur to those skilled in the art that, while not specifically shown herein, are nevertheless within the true spirit and scope of the invention.

What is claimed is:

1. A method for monitoring and managing multiple data storage devices in association with multiple computers, the method comprising:
obtaining at a data storage device manager a value for an attribute associated with at least one data storage device that is accessible to a first computer;
obtaining at the data storage device manager a value for an attribute associated with at least one data storage device that is accessible to a second computer that is separate from the first computer;
determining at the data storage device manager whether any of the attribute values meets a predefined condition that is associated with the attribute; and
if any of the attribute values meets the predefined condition, causing any of the computers from which the attribute value was received to perform a maintenance operation in association with the data storage device that is associated with the attribute value.

2. The method according to claim 1 wherein the obtaining steps are performed with respect to different data storage devices.

3. The method according to claim 1 wherein the obtaining steps are performed wherein the attribute associated with the attribute value of the first obtaining step is the same as the attribute associated with the attribute value of the second obtaining step.

4. The method according to claim 1 wherein the obtaining steps are performed wherein the attribute associated with the attribute value of the first obtaining step is different from the attribute associated with the attribute value of the second obtaining step.

5. The method according to claim 1 wherein any of the obtaining steps comprises obtaining wherein the attribute is a fragmentation level.

6. The method according to claim 1 wherein the determining step is performed at a third computer that is separate from the first computer and the second computer.

7. The method according to claim 1 wherein the causing step comprises performing the maintenance operation on the data storage device via the computer to which the data storage device is accessible.

8. The method according to claim 7 wherein the causing step comprises causing wherein the maintenance operation modifies the attribute value of the data storage device.

9. The method according to claim 8 wherein the causing step comprises causing wherein the maintenance operation comprises performing a defragmentation operation.

10. The method according to claim 1 and further comprising generating a report based on the attribute values for each of the data storage devices.

11. A system for monitoring and managing multiple data storage devices in association with multiple computers, the system comprising:
a DSD attribute collector configured to
obtain a value for an attribute associated with at least one data storage device that is accessible to a first computer, and
obtain a value for an attribute associated with at least one data storage device that is accessible to a second computer that is separate from the first computer;
an attribute analyzer configured to determine whether any of the attribute values meets a predefined condition that is associated with the attribute; and
a DSD agent configured to cause a maintenance operation to be performed in association with any of the data storage devices associated with any of the attribute values that meets the predefined condition.

12. The system according to claim 11 wherein the DSD agent is configured to provide the attribute values to the DSD attribute collector.

13. The system according to claim 11 wherein the DSD agent is configured with the first computer and a second DSD agent is configured with the second computer.

14. The system according to claim 11 wherein the attribute values are for the same attribute.

15. The system according to claim 11 wherein the attribute values are for different attributes.

16. The system according to claim 11 wherein the DSD attribute collector and the attribute analyzer are implemented by a third computer.

17. The system according to claim 9 wherein the attribute is a fragmentation level.

18. The system according to claim 9 wherein the DSD agent is further configured to perform the maintenance operation on any of the data storage devices associated with any of the attribute values that meets the predefined condition.

19. The system according to claim 9 wherein the maintenance operation modifies the attribute value of the data storage device regarding which the maintenance operation is performed.

20. The system according to claim 19 wherein the maintenance operation is a defragmentation operation.

21. The system according to claim 11 and further comprising a mapper that is configured to generate a report based on the attribute values for each of the data storage devices.

22. The system according to claim 11 wherein the DSD attribute collector, attribute analyzer, and DSD agent are embodied in any of
a) computer hardware, and
b) computer software embodied in a non-transitory, computer-readable medium.

23. A computer program product for monitoring and managing multiple data storage devices in association with multiple computers, the computer program product comprising:
a computer-readable storage medium; and
computer-readable program code embodied in the computer-readable storage medium, wherein the computer-readable program code is configured to
obtain at a data storage device manager a value for an attribute associated with at least one data storage device that is accessible to a first computer,
obtain at the data storage device manager a value for an attribute associated with at least one data storage device that is accessible to a second computer that is separate from the first computer,
determine at the data storage device manager whether any of the attribute values meets a predefined condition that is associated with the attribute, and
if any of the attribute values meets the predefined condition, cause any of the computers from which the attribute value was received to perform a maintenance operation in association with the data storage device that is associated with the attribute value.
